(19) United States
(12) Patent Application Publication
(10) Pub. No.: US 2009/0170375 A1
(43) Pub. Date: Jul. 2, 2009

(54) CONNECTOR APPARATUS FOR VIDEO AND AUDIO SIGNAL TRANSFER AMONG MULTIPLE DEVICES AND SYSTEM INCORPORATING SAME

(76) Inventors: Mervin A. Dayan, Oakhurst, NJ (US); Larry D. Sharp, Tinton Falls, NJ (US)

Correspondence Address: Cozen O''Connor, 250 Park Avenue, New York, NY, 10177, US

(21) Appl. No.: 11/964,589

(22) Filed: Dec. 26, 2007

(51) Int. Cl. H01R 25/00

(52) U.S. Cl. 439/650

(57) ABSTRACT

A jack and plug connector for use with a multimedia playing device used in a vehicle. The multimedia playing device is mounted within the dashboard of a vehicle and is able to wirelessly transmit video to various display devices located in the vehicle. The jack and plug connector provides the capability of transferring video and audio data from an auxiliary device to the multimedia playing device in the vehicle.

### CROSS REFERENCE TO RELATED APPLICATIONS

The present application claims the benefit of U.S. Provisional Application Ser. No. 60/871,552 filed on Dec. 22, 2006, the entirety of which is hereby incorporated by reference.

### FIELD OF THE INVENTION

The present invention relates generally to vehicle entertainment systems, and specifically to a connector for transferring video and audio signals from an auxiliary media device to a vehicle multimedia playing device.

### BACKGROUND OF THE INVENTION

In today's vehicles increasing measures are being taken to supply entertainment to the passengers. In the past, passengers were content with radios and other simple audio devices. As time went by, more sophisticated systems have been developed in order to provide entertainment to passengers.

Although the ability to play videos has been provided to passengers in the past, there has been an inadequate provision of access to a variety of mediums on which video data may be stored. Additionally, there is frequently inadequate reproduction of the audio data that accompanies the video data as well as a failure to provide an easy and non-cumbersome way of transmitting the information between devices.

Thus, there is a need for a comprehensive multimedia player that is able to provide a passenger with the ability to accommodate a variety of media sources as well as enable adequate and easy reproduction of audio and video data.

### SUMMARY OF THE INVENTION

It is therefore an object of the present invention to provide a system that provides for comprehensive provision of audio and video data to passengers of a vehicle.

Another object of the present invention is to provide a system that is able to wirelessly transmit video data to display devices located within a vehicle.

Still another object of the present invention is to provide an apparatus and system for transmitting audio data to the audio system of a vehicle.

Yet another object of the invention is to provide the capability of accommodating a variety of video and audio sources.

Another object of the invention is to provide the ability to connect more than one cable through a jack in the media playing device.

These and other objects are met by the present invention, which in one aspect can be a connection apparatus for transferring video and audio signals to a media playing device in a vehicle comprising: a first jack for coupling the apparatus to a video signal generating device; a second jack for coupling the apparatus to a audio signal generating device; a plug having at least three segments for transfer of video and audio signals to a media playing device in a vehicle and a ground segment for providing electrical shielding; and wherein the plug is adapted to connect to a media playing device in a vehicle.

In a further aspect the invention can be a system for providing auxiliary audio and video signals to a media player in a vehicle comprising: a jack and plug connector for transferring audio and video signals from an auxiliary device to a media player, the connector comprising: a first jack for coupling the jack and plug connector to a video signal generating device; a second jack for coupling the jack and plug connector to a audio signal generating device; a plug having a first segment for transferring a video signal to a media player, a second segment for transferring an audio signal to a media player, a third segment for transferring an audio signal to a media player and a ground segment for providing electrical shielding; a third jack attached to a media player having at least four receiver segments; and wherein the plug of the jack and plug connector is inserted into the third jack so that the first, second, third and ground segments of the plug each contact one of the at least four receiver segments of the third jack.

In a yet further aspect the invention can be a system for playing video and audio in a vehicle comprising: a media player for playing video and audio data having a jack, wherein the media player is adapted to be installed in a dashboard of a vehicle; a transmitter located within the media player, wherein the transmitter is adapted for wirelessly transmitting the video data to a display device; means for connecting the media player to an audio system of a vehicle, wherein the audio data played by the media player is sent to the audio system of the vehicle; the display device having a means for mounting the display device within a passenger compartment of the vehicle, the display device further comprising a receiver for receiving the video data; a display controller operably connected to the receiver for displaying the video data on the display device; a jack and plug connector for transferring video and audio data from an auxiliary device to the media player, the jack and plug connector comprising: a first jack for coupling the connector to a video data generating device; a second jack for coupling the connector to a audio data generating device; a conductive plug having at least three segments for transfer of video and audio data to the media player and a ground segment for providing electrical shielding; and wherein the plug is adapted to connect to the jack of the media player.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of the multimedia playing device according to an embodiment of the present invention.

FIG. 2 is a front view of the display device for use with the multimedia playing device shown in FIG. 1, according to an embodiment of the present invention.

FIG. 3 is schematic illustrating an arrangement of the multimedia playing device and the display device shown in FIGS. 1 and 2, according to an embodiment of the present invention.

FIG. 4 is diagram illustrating the interaction of the components of the system shown in FIG. 3, according to an embodiment of the present invention.

FIG. 5a is top view of a jack and plug connector, according to one embodiment of the present invention.

FIG. 5b is a front perspective view of the jack and plug connector shown in FIG. 5a, according to one embodiment of the present invention.

FIG. 6a is a diagram of the components of the jack and plug connector shown in FIGS. 5a-5b, according to one embodiment of the present invention.

FIG. 6b is a circuit diagram of the jack and plug connector shown in FIG. 5a, according to one embodiment of the present invention.

FIG. 7a is top view of a jack and plug connector, according to a second embodiment of the present invention.

FIG. 7b is a perspective front view of the jack and plug connector shown in FIG. 7a, according to a second embodiment of the present invention.

FIG. 8a is a diagram of the components of the jack and plug connector shown in FIGS. 7a-7b, according to a second embodiment of the present invention.

FIG. 8b is a circuit diagram of the jack and plug connector shown in FIG. 7a, according to a second embodiment of the present invention.

### DETAILED DESCRIPTION OF THE DRAWINGS

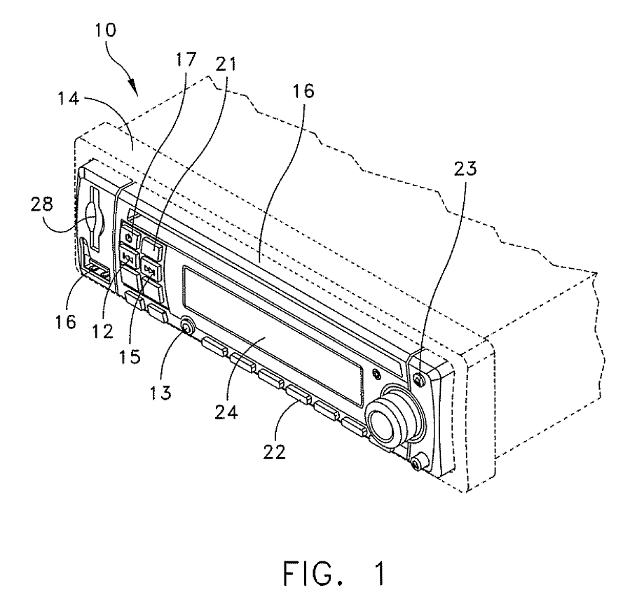

FIG. 1 is a view of the multimedia playing device 10 according to an embodiment of the instant invention. The multimedia playing device 10 is designed so as to be installed into the dashboard of a vehicle similar to the way in which traditional car stereos are installed. It may be pre-installed in a vehicle or designed to be placed within the dashboard of the vehicle after a vehicle has been sold.

The multimedia playing device 10 comprises a housing 14 in which the components of the multimedia playing device 10 are contained. The housing 14 has a front face on which the controls are located as well as the various ports and slots that receive the media devices on which video and audio data are stored and/or transferred from.

In the embodiment shown in FIG. 1, multiple types of media devices may be accommodated. The slot 16 is adapted to receive an optical disc for playback. The optical disc may be a Digital Video Disc (DVD), a Compact Disc (CD) or another type of optical disc. In preferred embodiments, the type of disc that is inserted is detected and playback of the disc on the optical disk player 73 commences based upon the format and type of disc.

A Universal Serial Bus (USB) port 18 is provided on the face of the housing 14 and is adapted to receive a USB plug. Typically, this USB plug is attached to an external media device that may store and/or play video and audio data. The device may be a personal computer, or a handheld device such as video Ipod® that stores video and audio data in some type of video and/or audio format. Video formats that may be used are MPEG4, AVI, WMV-9, and DRM. Audio formats that may be used are MP3, WMA, OGG, VGF, WAV, etc. The video and audio data from the external media device is transferred to the controller 72 through the USB port 18 for playback.

A Secure digital (SD) card port 26 is provided on the face of the housing 14 and is adapted to received a SD card. An SD card is capable of storing large amounts of data in a very small space. The SD card port 26 is operably connected to the controller 72. When an SD card is placed in the card port 26 the controller 72 is able to process the data contained on the card.

Other types of ports and/or slots may be provided in the face of the housing 14 in order to accommodate additional types of media devices, such as IEEE 1394 ports and HDMI cables.

Still referring to FIG. 1, various other features are located on the face of the housing 14 that function to enable operation of the multimedia playing device 10. A power button 17 is provided on the face of the housing 14 and is depressed in order to turn the multimedia playing device 10 on and off. A power indicator light 23 is also provided on the face of the housing 14 in order to indicate whether or not the multimedia player device 10 is turned on or not.

A mode button 21 may be used to switch the multimedia playing device 10 between various operation modes, such as switching between activating the radio, or to send a signal in order to indicate that data should be received from the SD card port 26, from the USB port 18 or from the optical disc player 73. The mode button 21 may also be used to indicate whether or not the audio should be played through the audio system 80 of the vehicle or should be transmitted to a display device 40. It is also possible to have the multimedia player device 10 detect the type of media that is being loaded and to automatically initiate playback upon detection of the media within the device as opposed to using the mode button 21.

Knob 12 is used to tune the radio multimedia player device 10. The display 24 shows the setting of the radio device as well as to display information related to the video and audio data that is being accessed. Pre-set button 22 is used to automatically switch the radio tuner to a desired setting.

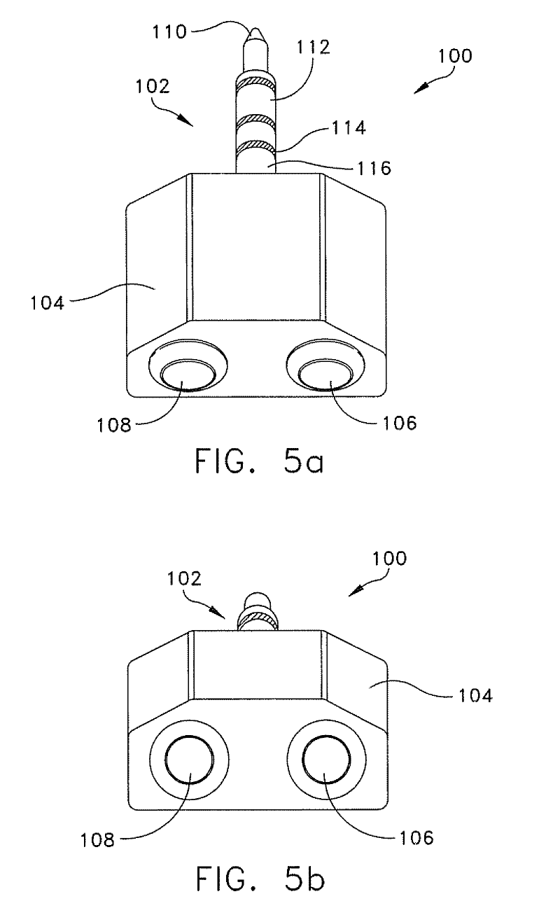

Also provided on the face of the housing 14 is an jack 13. Jack 13 may be a standard 3.5 mm jack that may be used in order to listen to audio through head phones. Alternatively, the jack 13 may be used in order to provide audio and/or video to and/or from an external media device or the display device 40. As will be discussed in further detail below, it may be possible to insert a jack and plug connector 100, shown in FIGS. 5a-8b below, into the jack 13 so that an external/auxiliary media device may transmit its video and audio data and/or signals.

Other standard video playback buttons are provided on the face of the housing 14, such as the fast forward button 15 and the rewind button 12. Other buttons such as pause, play, skip, etc. may also be provided. Other features such as an infrared sensor may also be located on the housing 14 so as to enable remote control of the functions of the media playback device 10.

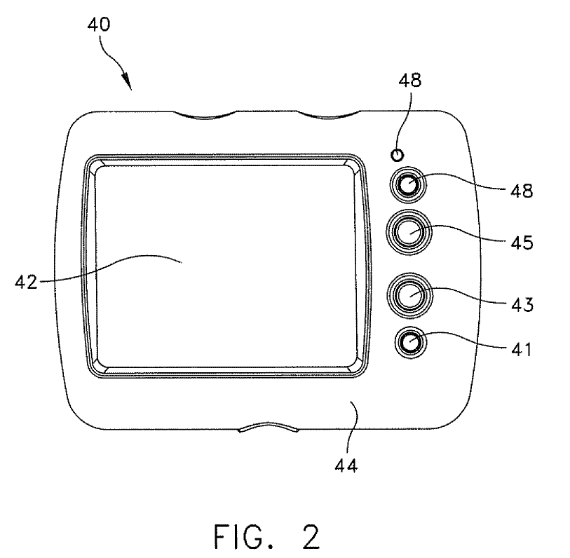

FIG. 2 is a view of a display device 40 that may be used with the multimedia player device 10 shown in FIG. 1, according to an embodiment of the instant invention. The display device has a housing 44 that houses the various components of the display device 40. The display screen 42 may be a LCD screen that may be sized to be readily placed within a vehicle and is typically between 3″ and 10″.

The display device 40 has a video input 46 that is provided on the display housing 44 that can accommodate a cable that can be extended from an external media device. It is intended that the video input 46 may receive video data for reproduction on the screen 42. It may also operate as means for charging the external media in some instances.

The display device 40 may have a series of controls located on the display housing 44. Some of the controls that may be provided are a contrast 48 that can control the contrast of video displayed on the screen 42 and a brightness 45 that can control the brightness of the picture shown on the screen 42. A power button 41 is used in order to turn the display device 40 on and off. The display device 40 may also be triggered to turn on when it receives video data from the media playback device 10.

The volume 43 may be an optional control that is used when the video input 46 is being used and is used to control the volume of audio that is produced by the display device 40. Alternatively, the volume 43 may control the audio in those instances where the audio is being transmitted from the multimedia player device 10 instead of being played through the vehicle's audio system.

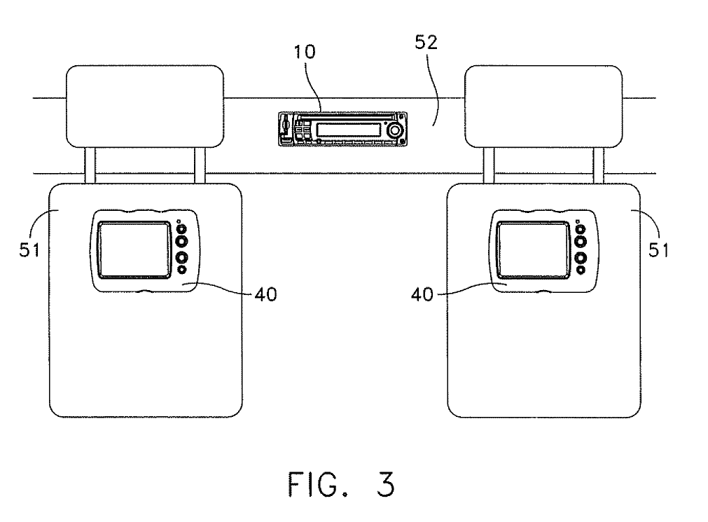

FIG. 3 is schematic illustrating an arrangement in a vehicle of the multimedia playing device 10 and the display device 40, shown in FIGS. 1 and 2, according to an embodiment of the instant invention. As shown the display devices 40 are placed upon the rear of seats 51. A display device 40 may be permanently mounted within the seat 51 or may be removably secured to the seat 51 using any number of attachment means such as straps, hook and loop tape, adhesive material, snap fixtures, etc. It is also possible to mount the display device 40 at other locations within the vehicle, such as in the front of a vehicle, or designed to fold down from the roof of the vehicle. The multimedia player device 10 may be mounted either permanently or removably within the dashboard 52 of a vehicle. Together the multimedia player device 10 and the display devices 40 may be part of a package that is installed in the vehicle at some point after the construction of the vehicle.

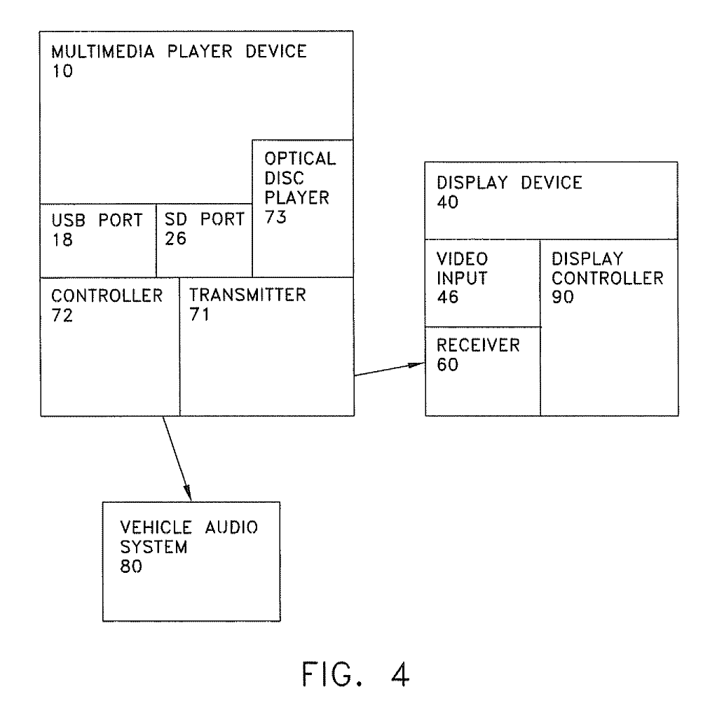

FIG. 4 is diagram illustrating the interaction of the components of the system shown in FIG. 3. The multimedia player device 10 has a controller 72 and a transmitter 71 as well as a number of means for reproducing video data, such as the optical disc player 73, the USB port 18 and the SD port 26. The multimedia player device 10 may also use a IEEE 1394 port (i.e. a firewire port). The controller 72 operates to receive the video data that is received from the various sources and to provide that video data to the transmitter 71. The controller 72 has the necessary drivers loaded thereon so that it is able to reproduce data that is transmitted by devices connected through the USB port 18 or from SD cards placed in the SD port 26.

For example, when a user of the multimedia player device 10 places a DVD disc into the slot 16 the optical disc player 73 will receive it. In a preferred embodiment, the optical disc player 73 is capable of playing both CDs and DVDs, in which case the optical disc player 73 first determines the format of the disc. When it is determined that a DVD disc has been placed within the optical disc player 73 the video and audio data read from the disc will be transmitted to the controller 72. When the video and audio data is received at the controller 72 it may be processed so that the data is split between the audio and the video data.

The video data will be sent to the transmitter 71, while the audio data is sent to the vehicle audio system 80 in order to provide audio throughout the vehicle. Preferably the video is transmitted at roughly 2.4 GHz to the display device 40. The vehicle audio system 80 may comprise pre-installed speakers in the vehicle, or speakers that have installed at some later point. In alternative embodiments that audio data may also be sent to the transmitter 71 for reproduction in the display device 40. If the audio data is transmitted to the display device 40 it may be transmitted at frequencies between 88.1-107.9 MHz or it may be transmitted at the same frequency as the video data.

Still referring to FIG. 4, after the video data is sent to the transmitter 71 it is transmitted to the receiver 60 of the display device 40. When the video data is received at the receiver 60 it is then transmitted to the display controller 90. The display controller 90 takes the video data and uses it to produce a picture on the screen 42 of the display device 40. In the event that audio data is also transmitted to the receiver 60, the display controller 90 will take the audio data and provide it the audio system of the display device 40.

In an alternative embodiment, it is possible for the display device 40 to also have a transmitter. In this embodiment, an external media device may be connected to the display device 40 through the video input 46. The video data would be sent to the display controller 72 in order to display the video on the screen 42. Audio data may also then be transmitted through the video input 46 or through a special audio input provided in the housing 44 of the display device 40. The audio data may be sent to the display controller 90 and then to a transmitter which would then transmit the audio data to a receiver located in the multimedia player device 10. The audio is preferably transmitted at a frequency between the range of 88.1-107.9 MHz. The multimedia player device 10 then transmits the data to the vehicle audio system 80.

FIGS. 5a and 5b show a top perspective view and a front perspective view of an embodiment of a jack and plug connector 100 that may be used with the media player device 10 shown in FIG. 1. It is to be understood that the jack and plug connector is in and of itself a novel device that can comprise an embodiment of the present invention. The jack and plug connector 100 is used to transfer video and/or audio signals from an auxiliary device to a media player such as the media player device 10 (shown in FIG. 1). The invention is not so limited, however, and the jack and plug connector 100 can be used with other multimedia playing devices.

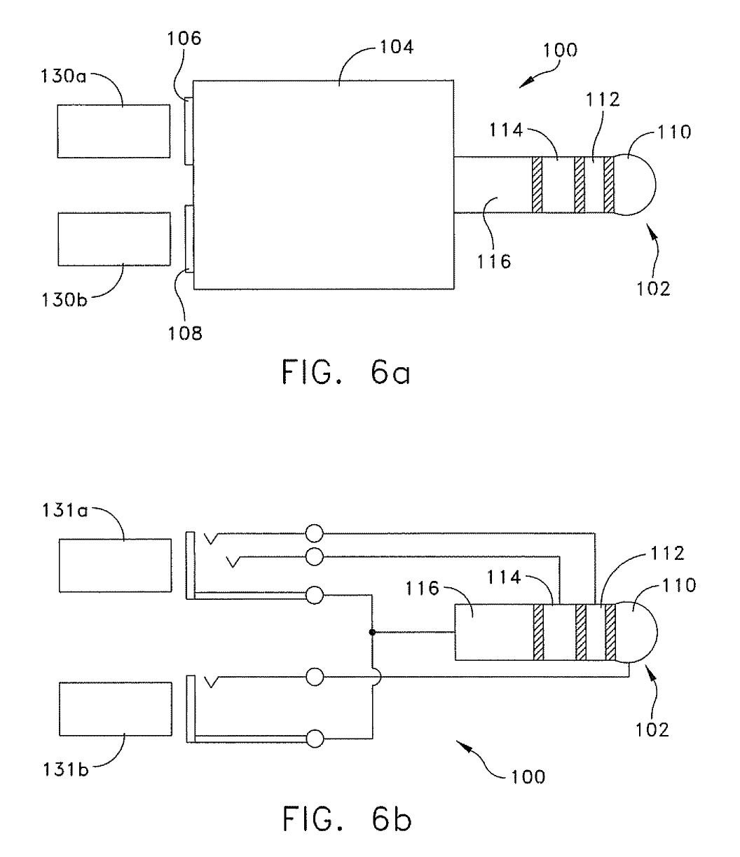

The jack and plug connector 100 has a housing 104 and a plug 102. The housing 104 may be a molded plastic housing) however it should be understood that the housing 104 may be constructed of any suitable material. Additionally, the size and shape of the housing 104 is not limiting of the invention and other coverings may be used including for example tubes. The plug 102 is a four pole 3.5 mm plug that is divided into four segments 110, 112, 114, 116. The segments 110, 112, 114, 116 are electrically isolated segments. The four segments 110, 112, 114, 116 comprise a video segment 110, the left audio segment 112, the right audio segment 114 and the ground segment 116. On the front of the housing 104 are a first jack 106 and a second jack 108 adapted to receive plugs from auxiliary devices 130a-b such as video ipods, video games or any other external media device that uses video and audio connectors. The first and second jacks 106, 108 are 3.5 mm jacks. The first jack 106 receives the audio data 131a from the external media device 130a and the second jack 108 receives the video data 131b from an external media device 130b (shown in FIGS. 6a 6b).

FIG. 6a is a diagram of the components of the jack and plug connector 100 shown in FIGS. 5a-5b. FIG. 6b is a circuit diagram of the jack and plug connector 100 shown in FIG. 5a and illustrates the interconnections between the segments of the plug 102 and the signals 131a, 13b from the first and second jack 106, 108. The jack and plug connector 100 is able to take the inputs from extemal/auxiliary media devices 130a-b and properly split and provide the data to a multimedia player device such as the multimedia player 10 through the jack 13 (or a standard 3.5 mm jack) located on the face of the housing 14 (shown in FIG. 1). The video segment 110 electrically connects to the video input 131b, the left audio segment 112 and the right audio segment 114 electrically connect to the audio input 131a and the ground segment 116 provides electrical shielding. When the jack and plug connector 100 is connected with a multimedia player, the plug 102 is inserted into a jack of the multimedia player device, like jack 13 (shown in FIG. 1). The jack of the multimedia player device comprises receiving segments that will couple with the segments 110, 112, 114, 116 of the pin 102. Each of the segments 110, 112, 114, 116 of the pin 102 will contact a segment of the jack so that the video and/or audio signals may be transferred to the multimedia device.

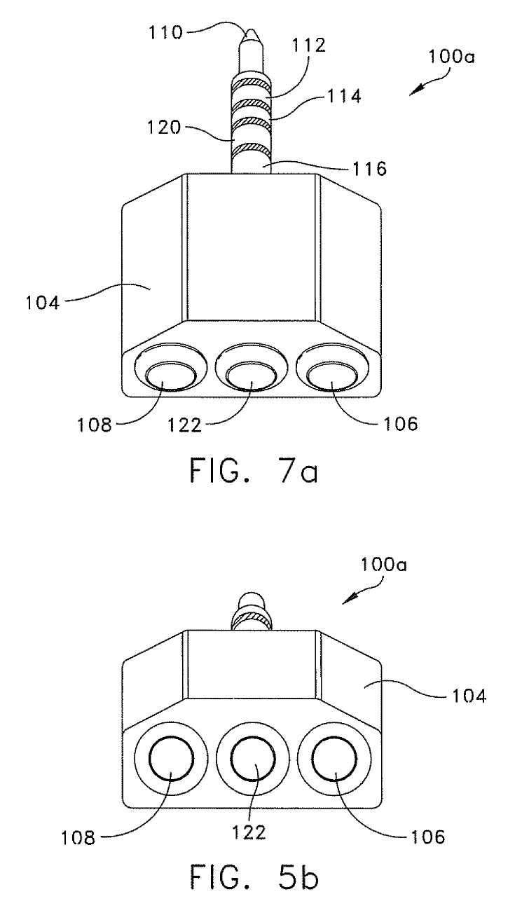

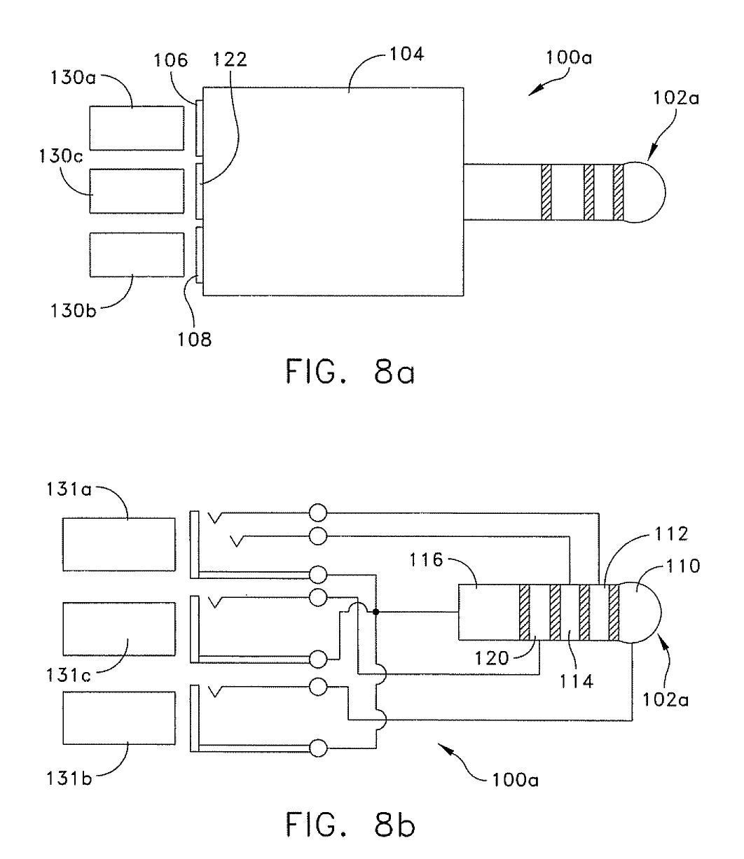

FIGS. 7a and 7b show a top view and a front perspective view of another embodiment of a jack and plug connector 100a for use with the media player device 10 shown in FIG. 1 (or any other multimedia playing device capable of receiving video and/or audio data). FIG. 8a is a diagram of the components of the jack and plug connector 100a shown in FIGS. 7a-7b. FIG. 8b is a circuit diagram of the jack and plug connector shown in FIG. 7a. The jack and plug connector 100a operates in the same fashion as the jack and plug connector 100 shown in FIGS. 5a-6b above, however it includes a wireless component jack 122 located on the housing 104. The wireless component jack 122 may take input plugs from a wireless device 130c like Bluetooth enabled devices. The plug 102a further comprises a microphone segment 120 that receives the signal 131c from the device 130c through the wireless component jack 122. The plug 102a is inserted through the jack 13 located on the housing 14 of the multimedia device 10 (shown in FIG. 1), or another multimedia device having a five pole input jack for receiving audio and/or video signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A connection apparatus for transferring video and audio signals to a media playing device in a vehicle comprising:
a first jack for coupling the apparatus to a video signal generating device;
a second jack for coupling the apparatus to a audio signal generating device;
a plug having at least three segments for transfer of video and audio signals to a media playing device in a vehicle and a ground segment for providing electrical shielding; and
wherein the plug is adapted to connect to a media playing device in a vehicle.

2. The apparatus of claim 1 wherein the at least three segments are electrically isolated segments.

3. The apparatus of claim 1 wherein the at least three segments are a video segment for receiving a video signal, a left audio segment for receiving an audio signal and a right audio segment for receiving an audio signal.

4. The apparatus of claim 1 further comprising:
a housing having a first side and a second side;
the plug connected to the first side of the housing; and
the first jack and the second jack formed in the second side of the housing.

5. The apparatus of claim 1 wherein the plug is compatible with 3.5 mm jacks.

6. The apparatus of claim 1 wherein the first and second jacks are compatible with 3.5 mm plugs.

7. The apparatus of claim 1 further comprising a wireless component jack and wherein the plug further comprises a microphone segment.

8. The apparatus of claim 7 further comprising:
a housing having a first side and a second side;
the plug connected to the first side of the housing; and
the first jack, the second jack and the wireless component jack formed in the second side of the housing.

9. A system for providing auxiliary audio and video signals to a media player comprising:
a jack and plug connector for transferring audio and video signals from an auxiliary device to a media player, the connector comprising:
a first jack for coupling the jack and plug connector to a video signal generating device;
a second jack for coupling the jack and plug connector to a audio signal generating device;
a plug having a first segment for transferring a video signal to a media player, a second segment for transferring an audio signal to a media player, a third segment for transferring an audio signal to a media player and a ground segment for providing electrical shielding;
a third jack attached to a media player having at least four receiver segments; and
wherein the plug of the jack and plug connector is inserted into the third jack so that the first, second, third and ground segments of the plug each contact one of the at least four receiver segments of the third jack.

10. The system of claim 9 wherein the jack and plug connector further comprises a wireless component jack, the plug further comprises a microphone segment and the third jack comprises at least five receiver segments.

11. The system of claim 10 wherein the plug of the jack and plug connector is inserted into the third jack so that the first, second, third, ground and microphone segments of the plug each contact one of the at least five segments of the third jack.

12. The system of claim 10 wherein the jack and plug connector further comprises:
a housing having a first side and a second side;
the plug connected to the first side of the housing; and
the first jack, the second jack and the wireless component jack formed in the second side of the housing.

13. A system for playing video and audio in a vehicle comprising:
a media player for playing video and audio data having a jack, wherein the media player is adapted to be installed in a dashboard of a vehicle;
a transmitter located within the media player, wherein the transmitter is adapted for wirelessly transmitting the video data to a display device;
means for connecting the media player to an audio system of a vehicle, wherein the audio data played by the media player is sent to the audio system of the vehicle;
the display device having a means for mounting the display device within a passenger compartment of the vehicle, the display device further comprising a receiver for receiving the video data;
a display controller operably connected to the receiver for displaying the video data on the display device;
a jack and plug connector for transferring video and audio data from an auxiliary device to the media player, the jack and plug connector comprising:
a first jack for coupling the connector to a video data generating device;
a second jack for coupling the connector to a audio data generating device;
a conductive plug having at least three segments for transfer of video and audio data to the media player and a ground segment for providing electrical shielding; and
wherein the plug is adapted to connect to the jack of the media player.

14. The system of claim 13 wherein the jack of the media player comprises at least four receiver segments and wherein the plug of the jack and plug connector is inserted into the jack of the media player so that the at least three segments and the ground segment of the plug each contact one of the at least four receiver segments of the jack of the media player.

15. The system of claim 14 wherein the at least three segments of the plug comprise:
a first segment for transferring video data from an auxiliary device to the media player;
a second segment for transferring audio data from an auxiliary device to the media player;
and a third segment for transferring audio data from an auxiliary device to the media player.

16. The system of claim 15 wherein the jack and plug connector further comprises a wireless component jack and the plug of jack and plug connector further comprises a microphone segment.

17. The system of claim 16 wherein the jack of the media player comprises five receiver segments.

18. The system of claim 17 wherein the jack and plug connector further comprises:
a housing having a first side and a second side;
the plug connected to the first side of the housing; and
the first jack, the second jack and the wireless component jack formed in the second side of the housing.

19. The system of claim 13, wherein the media player comprises;
a housing adapted for placement within a dashboard of a vehicle;
a first port located on a front face of the housing, wherein the first port is adapted to receive video and audio data stored on an external media device;
a slot located on the front face of the housing, wherein the slot is adapted to receive an optical disc and provide the optical disc to an optical disc reader;
a controller operably connected to the first port and the optical disc reader.

20. The system of claim 13, further comprising a second port located on a front face of the housing, wherein the second port is adapted to receive video and audio data stored on a media storage device and is operably connected to the controller.
